(19) United States
(12) Patent Application Publication
(10) Pub. No.: US 2017/0335604 A1
(43) Pub. Date: Nov. 23, 2017

(54) Magnetic lock

(71) Applicant: GUANGZHOU PRODIGY DAILY-PRODUCTION CO., LTD, Guangzhou (CN)

(72) Inventor: Zhanpeng LIANG, Guangzhou (CN)

(73) Assignee: GUANGZHOU PRODIGY DAILY-PRODUCTION CO., LTD, Guangzhou (CN)

(21) Appl. No.: 15/246,559

(22) Filed: Aug. 25, 2016

(30) Foreign Application Priority Data
May 19, 2016 (CN) 201620468817.6

(51) Int. Cl. E05B 65/44; E05C 1/12; E05B 65/00; E05C 19/16; E05B 47/00

(52) U.S. Cl. CPC E05B 65/44; E05C 19/16; E05B 47/004; E05B 65/0014; E05C 1/12

(57) ABSTRACT

The invention discloses a magnetic lock, comprising a lock body mechanism and a stopper, wherein the lock body mechanism comprising a housing, a swinging fastener, an inner cover, a latch for engaging with the stopper, and a magnetic unlocking member for controlling disengagement of the latch from the stopper; the swinging fastener is hinged to the inner cover, the inner cover is snapped with the housing, the latch is slidably arranged inside the housing, the swinging fastener comprises a push rod abutting against the latch, and the magnetic unlocking member is used to form a repulsive force applied to the swinging fastener to drive the latch away from the stopper. Unlocking the latch may only be achieved by means of magnetic unlocking member which is independent from the lock body mechanism so as to prevent children from opening this magnetic lock arbitrarily and which is also convenient to use.

### TECHNICAL FIELD

The present invention relates to the field of locksets, in particular relates to a magnetic lock for preventing children from opening a drawer.

### BACKGROUND

The desk is a common furniture and generally has a drawer, a drawer may contain a variety of items inside, and the front side of the drawer is provided with a front panel. However, families with children encounter a problem that many children is very curious about the items placed in the drawer and always like to look over the items inside. The items within the drawer would easily cause harm to children, and thus in order to prevent children from open the drawer arbitrarily, parents will usually lock the drawer; however, if the key is not removed in time, it is very likely to cause harm to children, while it would be easy to lose the key if the key is removed leading to difficulty in retrieving the items within the drawer and thus a problem of very inconvenient use.

### SUMMARY OF THE INVENTION

In order to overcome the disadvantages in the art, the object of the present invention is to provide a magnetic lock to implement unlocking of the latch only by means of a magnetic unlocking member independent from the lock body mechanism, so as to prevent children from opening this magnetic lock arbitrarily and the magnetic lock is also convenient to use.

The object of the present invention is achieved by using the technical solution as follows:

a magnetic lock, comprising a lock body mechanism and a stopper, wherein the lock body mechanism comprising a housing, a swinging fastener, an inner cover, a latch for engaging with the stopper, and a magnetic unlocking member for controlling disengagement of the latch from the stopper, and the swinging fastener is hinged to the inner cover, the inner cover is snapped with the housing, the latch is slidably arranged inside the housing, the swinging fastener comprises a push rod abutting against the latch, and the magnetic unlocking member is used to form a repulsive force applied to the swinging fastener to drive the latch away from the stopper.

Preferably, the swinging fastener further comprises a magnetic attraction member accommodating a first magnetic body therein.

Preferably, the lock body mechanism further comprises a second magnetic body mounted on the latch, the first magnetic body and the second magnetic body are magnets with opposite polarities, and the first magnetic body is used for providing an attractive force to the second magnetic body to drive the latch for the engagement with the stopper.

Preferably, both of the first and second magnetic bodies are in a rectangular shape.

Preferably, the magnetic unlocking member comprises a case and a third magnetic body fixedly mounted within the case, and the third magnetic body is used for providing an attractive force applied to the first magnetic body to drive the latch away from the stopper.

Preferably, the third magnetic body is in a cylindrical shape.

Preferably, the magnetic unlocking member further comprises a fixing sheet detachably mounted at a bottom of the case, a key cap engaged with the case, an elastic washer sandwiched between the key cap and the case, a double-sided adhesive tape mounted at a bottom of the fixing sheet, and an iron sheet mounted between the fixing sheet and the double-sided adhesive tape.

Preferably, the magnetic lock further comprises an open/close button arranged on the housing, a protruding end of the power button abuts against the latch, and the sliding of the latch is controlled by the opening and closing of the open/close button.

Compared with the prior art, the beneficial effects of the present invention lie in that the magnetic lock of the present invention is in a locked state in the absence of external forces, so that the drawer can be opened only using the magnetic unlocking member, so as to effectively prevent children from breaking the magnetic locking to open the drawer to rummage through items, thereby protecting the children.

### BRIEF DESCRIPTION OF THE DRAWINGS

FIG. 1 is a perspective view of a magnetic lock of the present invention;

FIG. 2 is an exploded view of the magnetic lock in FIG. 1;

FIG. 3 is a perspective view of a magnetic unlocking member of the present invention;

FIG. 4 is an exploded view of the magnetic unlocking member in FIG. 3;

FIG. 4 is an exploded view of the magnetic unlocking member in FIG. 3:

In the figures: 1. lock body mechanism; 2. first double-sided adhesive tape; 3. stopper; 4. lock sleeve; 5. housing; 6. open/close button; 7. spring; 8. toggle piece; 9. switch base; 10. latch; 11. first magnetic body; 12. swinging fastener; 13. inner cover; 14. lock seat; 15. second double-sided adhesive tape; 16. second magnetic body; 17. second screw; 18. stop portion; 19. protruding end; 20. push rod; 21. magnetic attraction member; 22. magnetic unlocking member; 23. key cap; 24. elastic washer; 25. third magnetic body; 26. case; 27. fixing sheet; 28. iron sheet; 29. third double-sided adhesive tape; and 30. first screw.

### DETAILED DESCRIPTION OF THE EMBODIMENT

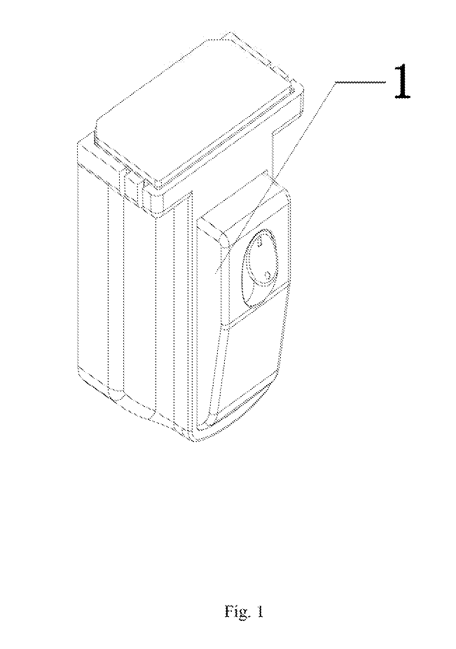

Herebelow, the invention will be further described in conjunction with the accompanying drawings and particular embodiments: as shown in FIGS. 1, 2, 3 and 4, a magnetic lock comprises a lock body mechanism 1 and a stopper 3, wherein lock body mechanism 1 comprises housing 5, swinging fastener 12, inner cover 13, latch 10 for engaging with stopper 3, and magnetic unlocking member 22 for disengaging latch 10 from stopper 3; and swinging fastener 12 is hinged to inner cover 13, inner cover 13 is snapped with housing 5, latch 10 is arranged inside housing 5 and slidable in the directions toward stop portion 18 and away from stop portion 18, and magnetic unlocking member 22 is used to form a repulsive force applied to swinging fastener 12 to drive latch 10 away from stopper 3.

When the drawer is closed, latch 10 is snapped with stopper 3, and then lock body mechanism 1 is engaged with stopper 3 for the function of locking; magnetic unlocking member 22 is disposed at a place adjacent to lock body mechanism 1, magnetic unlocking member 22 generates a repulsive force applied to swinging fastener 12 so as to drive the clockwise rotation of swinging fastener 12 which in turn drives the rotation of push rod 20, and since one end of push rod 20 abuts against latch 10, push rod 20 pushes latch 10 in the direction away from stopper 3, so as to achieve the purpose of unlocking; furthermore, housing 5 is snapped with inner cover 13 so as to accommodate swinging fastener 12 and latch 10 therein to form lock body structure 1.

Stopper 3 extends out of stop portion 18 and vertically toward the surface of latch 10 to stop latch 10, so as to fix the drawer; and first double-sided adhesive tape 2 is provided on the other surface.

It is essential that swinging fastener 12 comprises magnetic attraction member 21 accommodating first magnetic body 11, and push rod 20, one end of push rod 20 being fixed to swinging fastener 12, and the other end thereof abutting against latch 10; second magnetic body 16 is mounted at latch 10, and second magnetic body 16 and first magnetic body 11 are magnets with opposite polarities, therefore first magnetic body 11 and second magnetic body 16 attract each other by the opposite poles; first magnetic body 11 is used for providing an attractive force to second magnetic body 16 to drive the latch for engaging with stopper 3, so as to drive latch 10 to slide toward stop portion 18; therefore under the combined action of first magnetic body 11 and second magnetic body 16, the latch 10 slides toward stop portion 18 and is in a locked state; and both first magnetic body 11 and second magnetic body 16 are preferably in a rectangular shape.

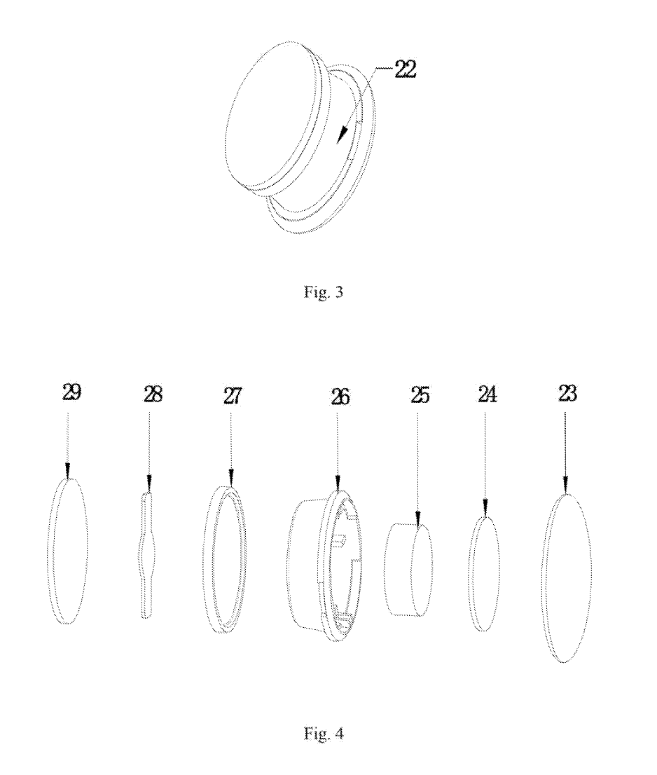

As shown in FIGS. 3 and 4, lock body mechanism 1 further comprises magnetic unlocking member 22, and magnetic unlocking member 22 comprises key cap 23, elastic washer 24, third magnetic body 25, case 26, fixing sheet 27, iron sheet 28 and third double-sided adhesive tape 29. Third magnetic body 25 is mounted within case 26; third magnetic body 25 is preferably in a cylindrical shape; elastic washer 24 is sandwiched between third magnetic body 25 and key cap 23 for a buffering effect; fixing sheet 27 is detachably mounted on bottom of the case 26; third double-sided adhesive tape 29 is mounted at a bottom of fixing sheet 27; and iron sheet 28 is mounted between fixing sheet 27 and third double-sided adhesive tape 29. Magnetic unlocking member 22 is disposed outside the drawer and adjacent to the magnetic lock, and since the attractive force generated by the attraction between the opposite poles of third magnetic body 25 and first magnetic body 11 is greater than the attractive force of first magnetic body 11 to second magnetic body 16, magnetic attraction member 21 accommodating first magnetic body 11 is actuated to drive swinging fastener 12 to rotate around the rotary shaft in the clockwise direction, so that push rod 20 pushes latch 10 to slide and separates the same from stopper 3, thereby implementing unlocking. Therefore, there is no need to lock or unlock the magnetic lock of the present invention with a key, and the magnetic lock is mounted inside the drawer, so that children can only open the drawer using magnetic unlocking member 22, so as to effectively prevent children from opening the drawer by breaking the magnetic lock.

In addition, in order to prevent children from playing with or losing magnetic unlocking member 22, third double-sided adhesive tape 29 on which fixing sheet 27 and iron sheet 28 are adhered is adhered to a required position, e.g., a high position, so that third magnetic body 25 is used to attract iron sheet 28, and that magnetic unlocking member 22 can be attached at the required position to prevent children from losing or playing with the same.

In the present invention, the locking and unlocking of the magnetic lock of the present invention can be achieved by utilizing the nature of magnets attracting substances such as iron, cobalt, nickel etc., and the principle in which the high-magnetism regions at two ends of the magnet, referred to as magnetic poles (one end as the north pole (N pole), and the other end as south pole (S pole)), repel each other when having the same magnetic polarity and attract each other when having different magnetic polarities. The present invention relates to three magnetic bodies, first magnetic body 11, second magnetic body 16 and third magnet 25, all three magnetic body being magnets.

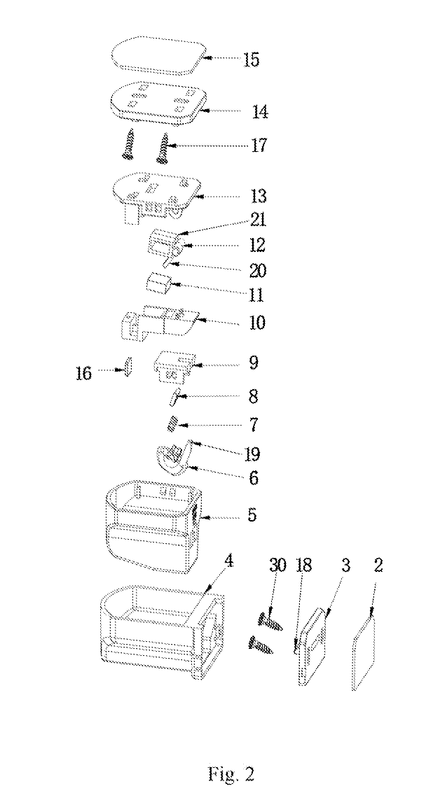

As shown in FIG. 2, the lock body mechanism 1 further comprises open/close button 6, open/close button 6 is fixed to housing 5 through spring 7, toggle piece 8 and switch base 9, and one end of open/close button 6 is provided with protruding end 19 abutting against latch 10.

In addition, the magnetic lock further comprises lock seat 14, and lock seat 14 is detachably connected to inner cover 13.

The installation procedure of the magnetic lock of the present invention is as follows:

before installation, the magnetic lock is an integral piece, i.e., both of lock body structure 1 and stopper 3 are accommodated within lock sleeve 4; open/close button 6 of the magnetic lock is switched to the position “-”, and then protruding end 19 drives latch 10 to slide in the direction away from stop portion 18, so as to achieve unlocking, and latch 10 is fixed; the top of the magnetic lock, i.e., stopper 3, is adhered to the top surface of the drawer through first double-sided adhesive tape 2, then the drawer is closed, second double-sided adhesive tape 15 is adhered to the front panel of the drawer, then lock body mechanism 1 is separated from stopper 3 and adhered to the front panel, and lock sleeve 4 is removed; then stopper 3 is fixed to the top surface of the drawer using first screw 30 passing through a through-hole (not shown) of stopper 3, and in addition since lock seat 14 is detachably connected to inner cover 13, lock body mechanism 1 can be removed; lock seat 14 is fixed to the drawer using second screw 17 passing through the through-hole (not shown) of lock seat 14; and then lock body mechanism 1 is installed again on lock seat 14; and finally open/close button 6 is adjusted to the position “O”, protruding end 19 is reset, and under the combined action of first magnetic body 17, second magnetic body 16 and third magnetic body 11, latch 10 is in a protruding position.

For a person skilled in the art, a variety of other corresponding modifications and variations can be made according to the technical solutions and conception described above, and all the modifications and variations shall fall within the scope of protection of the claims of the present invention.

1. A magnetic lock, comprising a lock body mechanism and a stopper, wherein the lock body mechanism comprising a housing, a swinging fastener, an inner cover, a latch for engaging with the stopper, and a magnetic unlocking member for controlling disengagement of the latch from the stopper; and the swinging fastener is hinged to the inner cover, the inner cover is engaged with the housing, the latch is slidably arranged inside the housing, the swinging fastener comprises a push rod abutting against the latch, and the magnetic unlocking member is used to form a repulsive force applied to the swinging fastener to drive the latch away from the stopper.

2. The magnetic lock according to claim 1, wherein the swinging fastener further comprises a magnetic attraction member accommodating a first magnetic body therein.

3. The magnetic lock according to claim 2, wherein the lock body mechanism further comprises a second magnetic body mounted on the latch, the first magnetic body and the second magnetic body are magnets with opposite polarities, and the first magnetic body is used for providing an attractive force to the second magnetic body to drive the latch for the engagement with the stopper.

4. The magnetic lock according to claim 3, wherein both the first and second magnetic bodies are in a rectangular shape.

5. The magnetic lock according to claim 1, wherein the magnetic unlocking member comprises a case and a third magnetic body fixedly mounted within the case, and the third magnetic body is used for providing an attractive force to the first magnetic body to drive the latch away from the stopper.

6. The magnetic lock according to claim 5, wherein the third magnetic body is in a cylindrical shape.

7. The magnetic lock according to claim 6, wherein the magnetic unlocking member further comprises a fixing sheet detachably mounted at a bottom of the case, a key cap engaged with the case, an elastic washer sandwiched between the key cap and the case, a double-sided adhesive tape mounted at a bottom of the fixing sheet, and an iron sheet mounted between the fixing sheet and the double-sided adhesive tape.

8. The magnetic lock according to claim 1, wherein the magnetic lock further comprises an open/close button arranged on the housing, a protruding end of the open/close button abuts against the latch, and the sliding of the latch is controlled by the opening and closing of the open/close button.
